(19) United States
(12) Patent Application Publication
(10) Pub. No.: US 2013/0091244 A1
(43) Pub. Date: Apr. 11, 2013

(54) INFORMATION MANAGEMENT SOFTWARE AND METHOD

(71) Applicant: Terence J. Mullin, Orange, CA (US)

(72) Inventor: Terence J. Mullin, Orange, CA (US)

(21) Appl. No.: 13/460,742

(22) Filed: Apr. 30, 2012

Related U.S. Application Data
(60) Provisional application No. 61/502,262, filed on Jun. 28, 2011.
(60) Provisional application No. 61/480,295, filed on Apr. 28, 2011.

(51) Int. Cl. H04L 29/08

(52) U.S. Cl. CPC H04L 29/08045
USPC 709/217

(57) ABSTRACT

A method is disclosed in which exhibitors or presenters at an event provide digital content to a content administrator, who in turn processes the digital content and loads it onto a content delivery device. At the event attendees are issued portable memory devices that, when engaged with a content delivery device, upload the digital content from that content delivery device. Each portable memory device has an information management software that enables the attendee to search, correlate and manage the digital content. In some embodiments digital content is loaded to the portable memory device without use of the content delivery device.

### CROSS-REFERENCE TO RELATED APPLICATIONS

This application claims priority to U.S. Application No. 61/480,295, Apr. 28, 2011, entitled “Information Management Software and Method”, and U.S. Application No. 61/502,262, filed Jun. 28, 2011, also entitled “Information Management Software and Method”. The entirety of the disclosure of each of these priority applications is hereby incorporated by reference. This application presents some embodiments that may relate to subject matter discussed in Applicant's previously filed U.S. application Ser. No. 12/576,205, filed Oct. 8, 2009, and Ser. No. 11/525,779, filed Sep. 22, 2006, now U.S. Pat. No. 7,979,430. The entirety of the disclosure of each of these related applications is hereby incorporated by reference.

### BACKGROUND OF THE INVENTION

1. Field

The present invention is in the field of digital content delivery.

2. Description of the Related Art

Exhibitions, such as trade shows, are held regularly in many industries in order to provide exhibitors an opportunity to demonstrate their wares to potential purchasers. Exhibitors typically occupy a demonstration booth or the like from which they may present their products and/or services. Traditionally, exhibitors offer printed product literature and/or software-based materials such as CDs and DVDs having product information for interested parties to take in order to learn more about the exhibitor's products or services. Such product literature and materials tends to be expensive both to produce and to transport to and from the exhibition.

Exhibition attendees also face challenges with traditional literature collection. For example, an exhibition attendee who is interested in many different products can quickly accumulate several pounds of paper literature, software-based materials, and other media, which the attendee must lug around the exhibition and eventually transport home. Further, such accumulation of paper literature and other media tends to get jumbled up and disorganized. Thus, the attendee likely loses track of certain literature that was obtained during the exhibition. Further paper-based materials are not easily searched, and are not readily shared with colleagues absent manual photocopying and distribution. On the other hand, software-based DVDs and CDs are not readily organized.

Similar concerns also arise in other contexts, whether it be distribution of materials in a formal or informal educational context, seminars, conferences, marketing or the like. Also, management of commercial literature, such as brochures and the like, requires attention and effort to ensure appropriate literature is kept up-to-date and available at appropriate locations.

### SUMMARY

Accordingly, there is a need in the art for a method for efficiently distributing digital content and managing and organizing such content to maximize its usefulness.

The present application discloses an information management software that enables management of digital content from disparate sources obtained from trade shows, exhibitions, retail interaction, marketing, and the like. The present application also discusses methods for delivering digital content along with information management software that enables one to use that content without searching for other applications.

### BRIEF DESCRIPTION OF THE DRAWINGS

FIG. 1 is a schematic illustration of a system and method in accordance with one embodiment.

FIG. 2 shows a screen shot from a user computer when copying digital content.

FIG. 3 shows a screen shot from a user computer when entering user information.

FIG. 4 shows a screen shot from a user computer showing a home page of an information management software.

FIG. 5 shows a screen shot from a user computer showing category searching in accordance with one embodiment.

FIG. 6 shows a screen shot from a user computer showing aspects of data managed in accordance with an embodiment.

FIG. 7 shows a screen shot from a user computer showing a landing page of an exhibitor's delivered digital content in accordance with an embodiment.

FIG. 8A shows a screen shot from a user computer showing categories applied to certain digital content in accordance with an embodiment.

FIG. 8B shows a screen shot from a user computer showing categories as modified by a user in accordance with an embodiment.

FIG. 8C shows a screen shot from a user computer showing modified categories used to manage digital content in accordance with an embodiment.

FIG. 9 shows a screen shot from a user computer showing creation of user defined categories in accordance with an embodiment.

FIG. 10 shows a screen shot from a user computer applying user defined categories to digital content in accordance with an embodiment.

FIG. 11 shows a screen shot from a user smart phone showing data exported from information management software.

FIG. 12 shows a screen shot from a user computer showing a home page corresponding to a tab of an embodiment of information management software.

FIG. 13 shows a screen shot from a user computer showing digital content delivered and corresponding to a category tree in accordance with an embodiment.

FIG. 14 shows a screen shot from a user computer showing search results configured in accordance with an embodiment.

FIG. 15 shows a screen shot from a user computer showing a prompt for concatenating disparate digital content with a single information management software embodiment.

FIG. 16 shows a screen shot from a user computer showing linking to social networking of entities from which digital content was obtain in accordance with an embodiment.

### DETAILED DESCRIPTION

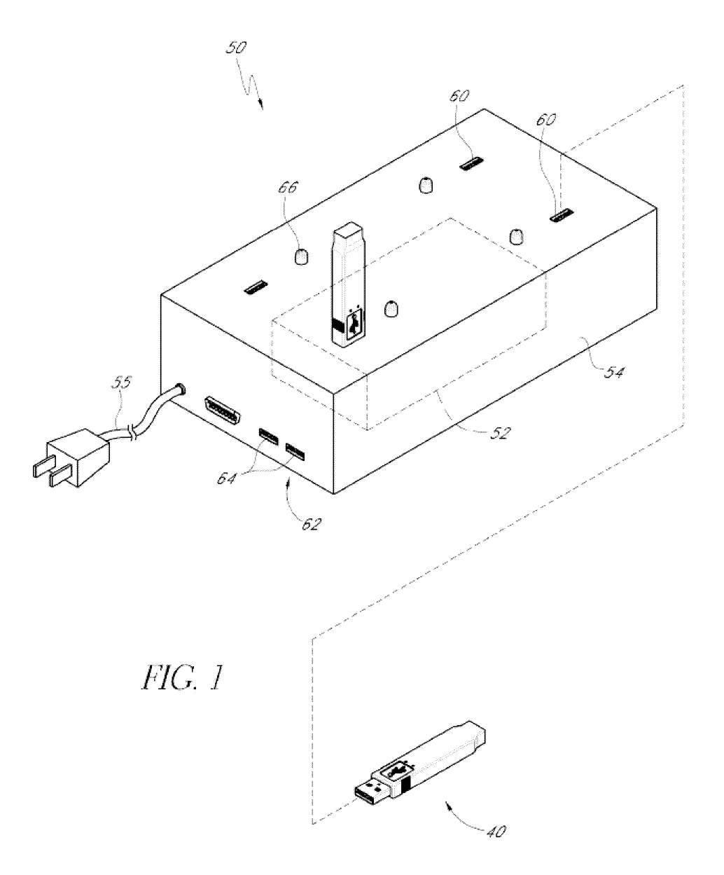

With initial reference to FIG. 1, an embodiment of a system and method for delivering digital content is presented. In order to aid presentation, the illustrated embodiment will be discussed in the context of a trade show, and a digital content administrator provides certain hardware and software to facilitate communication of digital content. In the illustrated embodiment the administrator gives an attendee, or user, a portable electronic memory storage device 40 for uploading electronic information from exhibitors, such as vendors.

In one embodiment, the portable electronic memory storage device 40 comprises a USB-based memory device such as a “flash memory” drive or “thumb drive.” Of course, it is to be understood that other types of portable electronic memory devices can be employed. For example, acceptable portable memory devices may include, without limitation, small card-based memory such as “compact flash” memory cards or “memory sheets,” hand-held computers, such as personal digital assistants (PDAs), laptop and/or tablet computers, smart phones and other small portable electronic devices that have an electronic memory that can store digital files in data, audio, video, or other formats.

In the context of a trade show, exhibitors generally have demonstration booths, kiosks, or the like at which they present information about their products. In the embodiment illustrated in FIG. 1, the administrator issues an exhibitor a content delivery device 50 that may be placed at or adjacent the exhibitor's booth. The content delivery device 50 preferably comprises a preprogrammed computing portion 52 which includes hardware such as a processor, a memory device such as a disk drive, solid state RAM, or the like, and includes software and/or firmware for running such hardware. A power cord 55 provides power for the device 50.

Preferably, the computing portion 52 of the content delivery device 50 is enclosed within a protective housing 54. The content delivery device 50 preferably also includes one or more interfaces 60, such as USB ports, that are in electronic communication with the computing portion 52. The interfaces 60 preferably are readily accessible, such as shown in FIG. 1, which depicts the interfaces 60 on a top of the housing 54. The illustrated content delivery device includes four interfaces 60, each of which is electronically linked to the computing portion 52. The illustrated device also has a connector section 62, which has one or more input connectors 64 for interfacing with an administrator computer. Preferably the connector section 62 is spaced from the interfaces 60 to avoid any confusion. The content delivery device 50 is loaded with digital content that the exhibitor would like to share with trade show attendees. In some embodiments the exhibitor submits the digital content to the administrator, who loads it onto the content delivery device 50.

With continued reference to FIG. 1, each portable electronic memory storage device 40 is capable of interfacing with the exhibitor's content delivery device 50. In the illustrated embodiment, a thumb drive 40 is configured to fit into the USB port 60 of the delivery device 50 so as to interface with the delivery device 50.

In the embodiment illustrated in FIG. 1, a vendor/exhibitor booth has a content delivery device 50 set up at or adjacent the booth. The memory portion 52 of the exhibitor's delivery device 50 preferably includes content comprising one or more electronic files of product information such as product specifications, brochures, videos, instruction manuals, sales literature and the like concerning products displayed and/or demonstrated at the exhibitor's booth. Such files may be in any desired format. For example, in one embodiment, at least some of such files are “.pdf”-type files, others are “.jpg”-type files, and others are “.wav” files. Other formats can be used as desired and as appropriate. In some embodiments, multiple files can be configured to work together. For example, an executable or introductory file can display a menu guiding the user to select which file(s) most closely match his interest.

In an example of operation in accordance with one embodiment, if an attendee is interested in a product being demonstrated by the vendor, the attendee engages his portable memory device 40 with an interface 60 of the vendor's delivery device 50. Preferably, electronic product information files of the vendor are saved in the memory portion 52 of the vendor's content delivery device 50. When the attendee's portable memory device 40 is engaged with the content delivery device 50, the vendor's product information files preferably are automatically uploaded from the memory unit 52 to the attendee's portable device 40. Once the upload is complete, the attendee removes the device from the interface 60 and can continue browsing other booths of the exhibition, each of which may have one or more of its own dedicated content delivery devices. Upon finding another interesting product at another vendor's booth, the user engages his portable memory device with the content delivery device of the chosen vendor, and thus obtains desired product information from the chosen vendor.

In some embodiments the attendee is matched to his portable device 40, such as by saving his contact information to the portable device 40 upon check-in at the trade show. In one embodiment each portable device 40 has an electronic identifier such as a serial number or the like, and that serial number is matched to the attendee's identity on the computer system of an administrator that administrates the data delivery devices of the trade show. Further, in some embodiments the content delivery device 50 is configured to copy the attendee's identifying information when engaged with the portable memory device. In other embodiments the content delivery device copies the identifier of the portable device.

It is anticipated that each attendee will interface with multiple, even several, exhibitors during the course of a day or other specified time at the trade show. Thus, there will be many electronic files stored on the attendee's portable device 40. Preferably an information management software package is pre-loaded on the portable memory device 40 to help the attendee organize and use the digital content collected at the show.

At the end of the show, or as desired, the attendee preferably engages the portable memory device 40 with the attendee's own computer, such as a laptop computer. The contents of the portable memory device, and specifically the product information uploaded from the exhibitor's content delivery device, is thus available to the attendee in electronic form and can be downloaded onto the attendee's computer, shared with others, or maintained on the portable device as desired by the attendee. More specifically, in some embodiments the information management software package is configured to run from the portable device without necessarily saving any data to the attendee's computer, but is also configured so that, if desired, both the management software package and the collected data can be loaded onto the attendee's computer and run locally on the computer.

In the present specification, a description of the information management software package will be described in the context of a file teaching a user (“You”) how to use the software in one embodiment, with occasional aside comments. The information management software will be referred to as “Presenter” software, content delivery devices will be referred to as “green boxes”, and a portable memory device will be referred to by variations of a “USB drive”. It is to be understood that the terms “Presenter”, “green boxes” and “USB drive” are used for convenience in the specification, and correspond to the broadly-defined respective terms “information management software”, “content delivery devices”, and “portable memory device”.

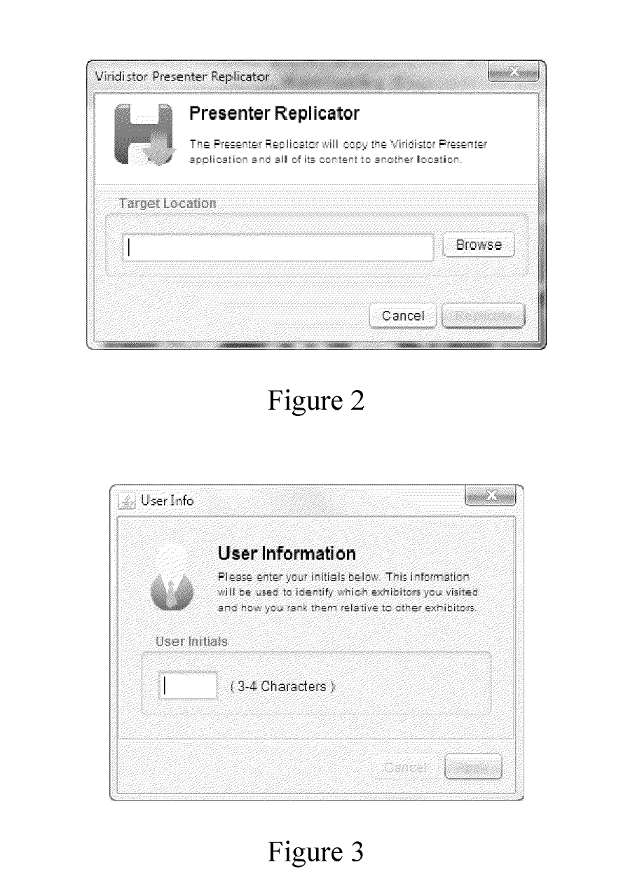

You may run the Presenter directly from the USB drive or move the Presenter application and content to your computer. To move the Presenter, from the File Menu, select the Tool item and Replicator selection. FIG. 2 illustrates a screen caption to enable you to copy the Presenter software and data collected to a target location on your computer or, in some embodiments, a network. Over time, you will build libraries of shows, conferences and events that you visit, so you will be able to build a library of the information you have gathered. In some embodiments, if you already have a copy of the Presenter software installed, the Replicator action will only copy the newly-acquired data.

Once you have connected your USB device to your computer, you can launch the Viridistor Presenter. The Viridistor Presenter gives you the ability to view and manage all of the content from the event, in addition viewing the Event Guide, and specialty information and advertisements from the event. The Presenter is a powerful tool to be used before (in some embodiments), during, and after an event to plan which exhibitors you wish to visit (and which exhibitors you actually visit) by Exhibitor Name or Booth Location, in addition to taking advantage of the Presenter's powerful Category filtering capabilities. In addition to the event created categories, the user may create user defined categories (UDC) in addition to assigning a visual rating of one to five stars (or, in other embodiments, any other type of rating system such as rating from the number “1” to the number “3”) for easy annotation of records. You also have the option of searching for a particular Exhibitor by name using the Find command. Even if you don't know all of the spelling of the Exhibitor name, the Find utility will present matches based upon the character you type in. When using the Find command, you can begin typing just a few letters of the item you are searching for and either selects the Find button or hit “enter.” Each execution of the Find or enter will move the selection to the next match until the end of the list is reached, at which point, the next Find will start from the top of the list again. By adding additional letters to the Find box, the user can fine tune the search and at the same time see matches that may be relevant. It is anticipated that additional embodiments will provide more powerful search and find capabilities.

The Presenter allows the user to print out exhibitors by category, sorted either by Exhibitor name or Booth location, in addition to allowing the user to export this information in comma separated value format to be used by other applications or devices, such as smart phones.

Another embodiment, referred to as the Presenter Manager edition, is a more powerful version of the Presenter that allows any “manager” to pull together, or concatenate, any number of Presenter sessions from one or more other users, including the individual user's categories, ratings, and content they captured. Additionally, in some embodiments the Presenter Manager has all the features of the standard Presenter.

To start the Presenter, double click on the Viridistor Presenter on the USB device. With reference next to FIG. 3, the first time that you start the Presenter, a dialog box will prompt you to enter your User Information that consists of your initials. Your 3 to 4 initials will be used to identify the content, ratings, and categories that you have gathered on the USB drive. You will have the ability to change your initials at any time via the Tools, Preferences on the menu bar. In other embodiments, other modes of identification can be used, such as registering the software, and taking identification data from such registration.

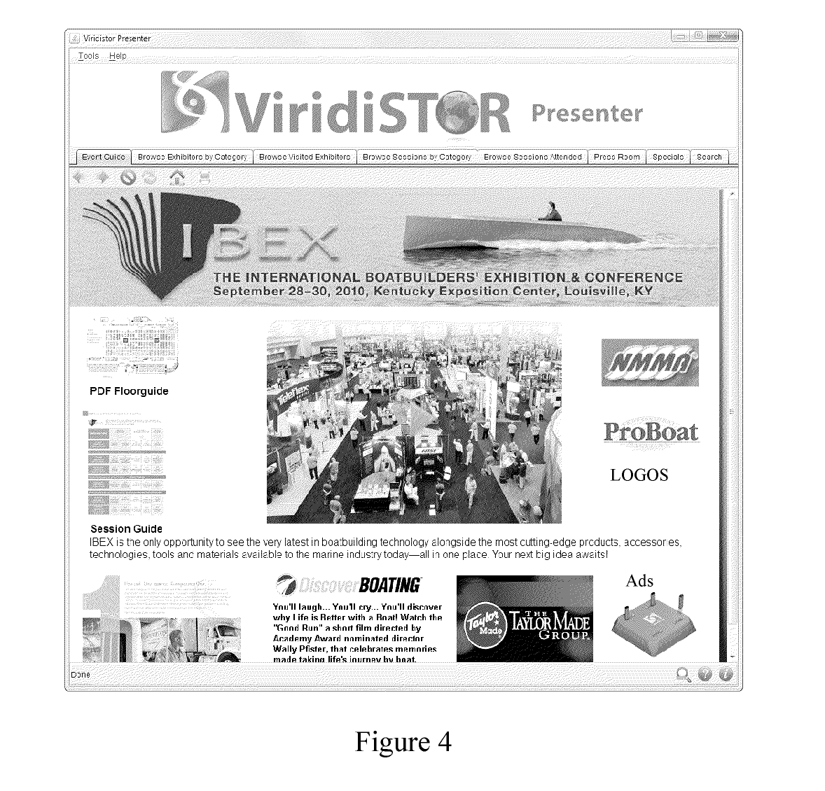

With reference next to FIG. 4, as you continue in this embodiment you will be taken to a main screen. In the illustrated embodiment the Presenter is comprised of eight tabs: Event Guide, Browse Exhibitors by Category, Brose Visited Exhibitors, Browse Sessions by Category, Browse Sessions Attended, Press Room, Specials and Search. Other embodiments may have more or less tabs.

The first tab is the Event Guide. Preferably information about the event is launched from this page, which includes the electronic equivalent of the event or conference guide, a link to a guide of conference sessions, a banner graphic representing the particular trade show, space to include a list of sponsors, which may include logos, a photograph of the floor of a previous, or the current, trade show, a summary description of the theme of the show, and spaces for advertising.

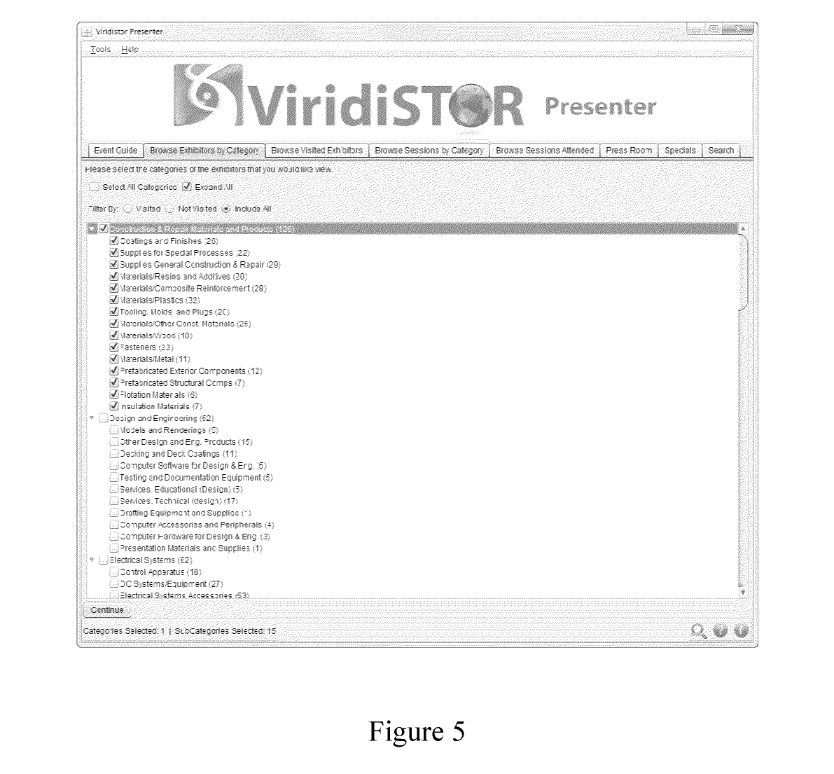

With reference next to FIG. 5, the Browse Exhibitors by Category tab takes you to a page that allows you to view all of the exhibitors/sessions of the event, filter by only the exhibitors/sessions that you have visited, or selectively choose which category or categories you wish to browse. This page includes options for managing filters, and also lists categories and subcategories that, in one embodiment, have been established by the administrator. Preferably, vendors/exhibitors have self-classified their products in relevant categories prior to the show, so each exhibitor is linked to a plurality of categories. Notably, information about every trade show exhibitor that has opted to be included is listed by the Presenter, whether or not you have visited the exhibitor's booth.

The Filters include “Visited” which filters the list by only the exhibitors/sessions that you have visited (meaning, you have interfaced your USB drive with that exhibitor's Green Box); “Not Visited,” which filters the list by only the exhibitors/sessions that you have not visited, and may wish to, and last “Include All”, which is the default setting that includes exhibitors/sessions that you have and have not visited. As the Presenter supports events that may have “primary category/secondary category” classifications, the “Expand All” opens the entire tree of the structure to view the information. Note that other embodiments may have more or less classifications. Also, in other embodiments you may filter by other factors, such as by vendors you identified before the event as vendors you wished to visit.

You will note that in the lower left hand side of the window that “Categories Selected: 1” and “Subcategories Selected: 15” is indicated. This tells you that only 1 of the available categories was selected and 15 subcategories were selected. You will also note a number surrounded by parenthesis to the right of each category which represents the number of exhibitors/sessions for that category. You will note that each of the 15 subcategories also tell you how many exhibitors were in the subcategory. Once you have selected the categories and which filter you wish to apply, the Continue button becomes active. Clicking on Continue activates the viewing pane of this tab.

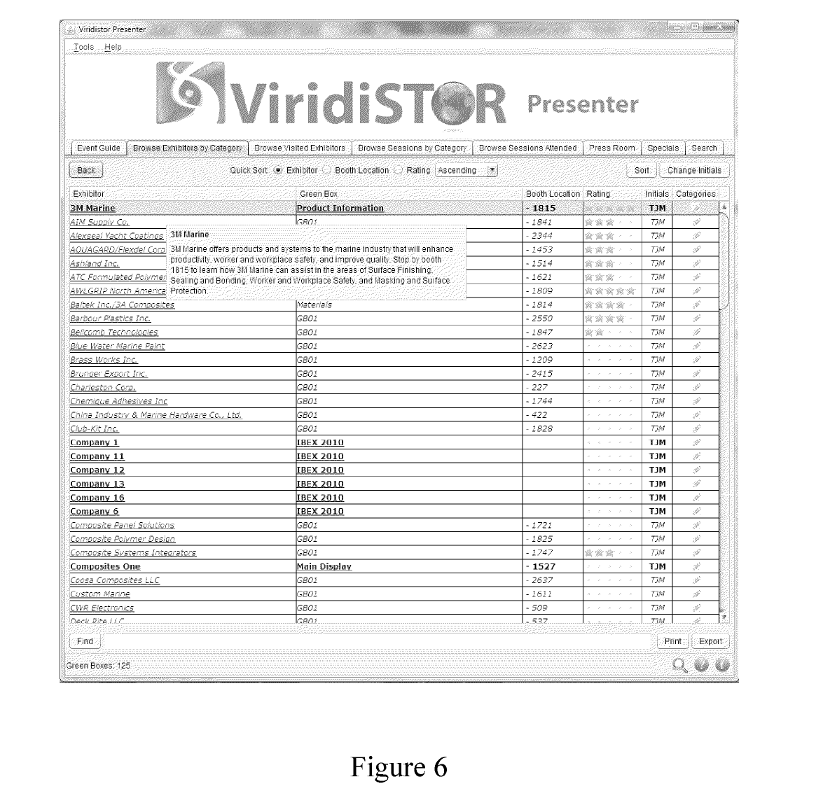

With reference next to FIG. 6, an embodiment of a viewing pane is shown. In this example, “Construction & Repair Materials and Products” was selected, which has 125 exhibitors in this category. You will also note that in the lower left hand side of the window that “Green Boxes: 125” is indicated. This tells you that in this category, for example there are 125 Green Boxes where information in this category was available. In many events, exhibitors will have more than one Green Box in their booth, some with the same information and some with a different selection of data, but may share the same category or categories.

The pane includes a Back button that can be used to take you back to the previous page to modify your selections. The Presenter also has the ability to quick sort the information by Exhibitor Name, Booth Location or Rating. This is accomplished by simply selecting the appropriate button.

In the illustrated embodiment there are two fonts in the display of information. If an exhibitor has been visited, they will appear in non-italic bold. If they have not been visited, they will appear in italic non-bold font. In the Exhibitor column, you are presented the name of the exhibitor. When you “mouse over” the exhibitor name, which means move the mouse pointer over the item, a tool tip box opens with the exhibitor synopsis (the same would go for conference sessions). Note that as you move your mouse up and down the list, the line is highlighted to ease in viewing all the information.

On the lower left section of the pane is the Find button and window. The Find allows you to search and find information from all of the fields. The Find command also allows you to type just some of the letters of the target you are searching for. The Find command is not case-sensitive. To execute the Find, type in just a few letters and click Find. The Find will take you to the first instance of the match. Additional clicks on Find will take you to the other matches.

Each Green Box can have a name as provided by the exhibitor. The name may be an internal code or can describe the product information available from that Green Box. When you mouse over the name of the Green Box in the “Green Box” column, a “tool tip” box opens with a synopsis of what particular content was loaded from this particular Green Box. This is very useful when exhibitors use more than one Green Box to deliver content. Hitting the ESC (escape) key at any time a tool tip is open will close it.

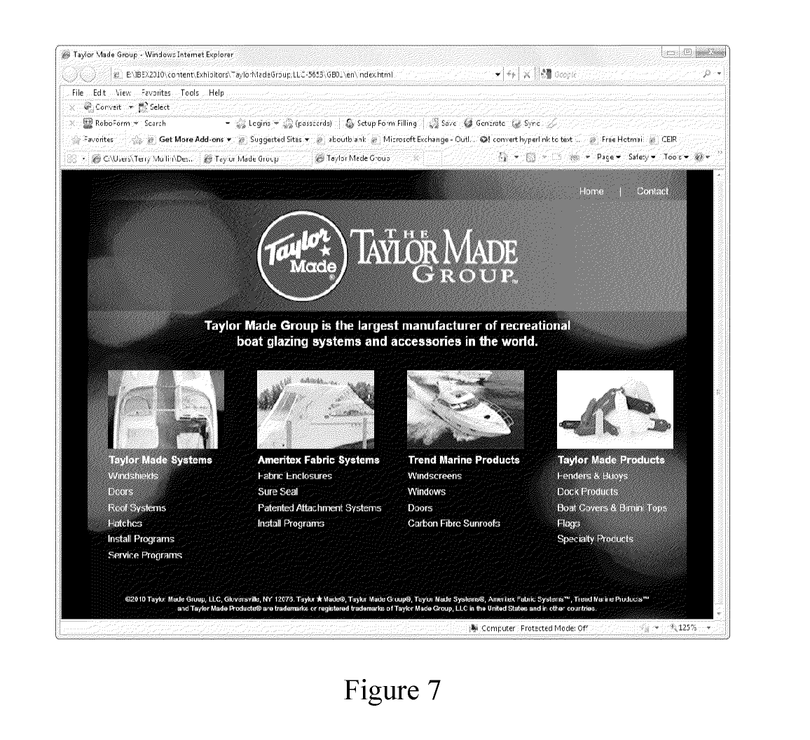

When you click on the bold link in the Green Box column (which corresponds to a Green Box you visited and obtained data from), it opens a browser session and loads the content that is on the USB drive. FIG. 7 illustrates an example of digital content. For example, the digital content provided by the exhibitor may include a graphical home page interface (as shown) with the exhibitor's trade mark, logo and brief description, and may also include links to digital content relating to families of its products, all of which is supplied on the USB drive. In other embodiments the digital content may be organized in more or less detail and ease of use, as preferably the content is supplied by an exhibitor, not the digital content administrator. Further, the USB drive may include a link that will contact the associated exhibitor and initialize an online sequence that will update the information stored on the drive (which was originally distributed at the trade show).

In the illustrated embodiment, with both the visited and not visited exhibitors, if you click on the link of their exhibitor name, instead of launching and presenting the content on the USB drive (only for those visited), instead it will launch the browser and take you directly to the Internet and the exhibitor's corresponding website. In many cases, exhibitors will create a special “landing page” specific to the event. As such, no exhibitor is ever completely missed, and for those who were visited, the information and or content can be instantly “refreshed” when they visit the live site of the exhibitor from the link provided on the USB drive.

The Booth Location column presents the physical booth location information for the exhibitor. Depending upon the event, it will either be the name of a room/conference room, hall and booth number, or simply a number of a booth where the exhibitor is located.

The Rating column is used to assign a visible rating for each exhibitor, visited or not. Mouse over the number of the stars you wish to assign for the exhibitor and click to lock your selection in. If at any time you wish to remove all star ratings, simply right-click and select “Remove Ratings.”

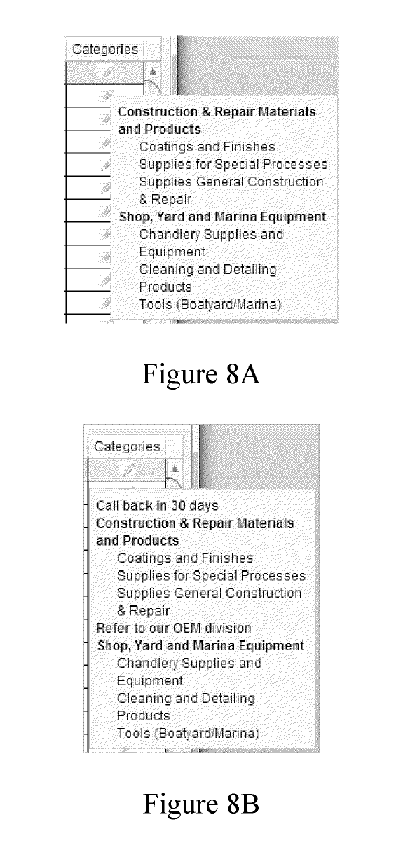

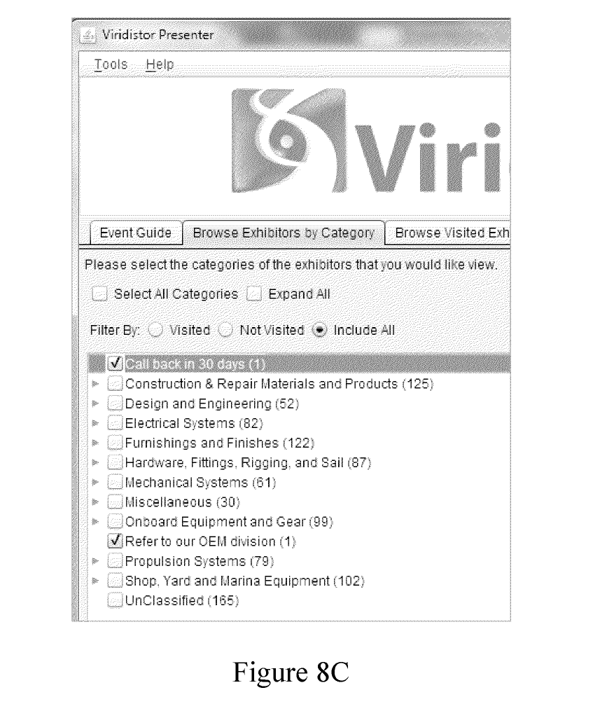

With additional reference to FIG. 8A, the last column in the illustrated embodiment is the Categories column. When you mouse over the icon in the column, a tool tip opens with the categories that were set by the exhibitor, in addition to any User Defined Categories, which can be set by the user of the Presenter. In FIG. 8A, the bolded text represents the primary category, and the non-bolded text represents the subcategory. In one embodiment you do not have the ability to change the categories the exhibitor selected for its company. In other embodiments you can change categories as you see fit.

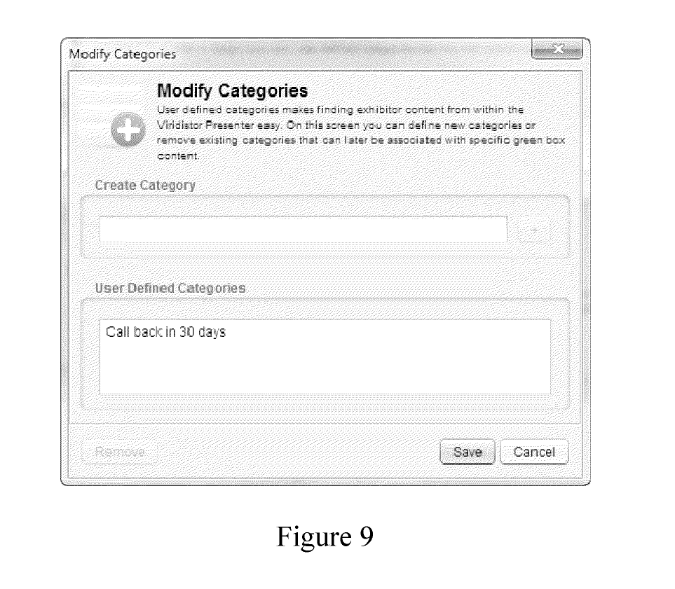

With reference next to FIG. 9, in another embodiment you may create User Defined Categories, or UDCs, by clicking a “Modify Categories” button, which will open a box as shown in FIG. 9, which will allow you to add or delete UDCs as you see fit. UDCs can include unique words or phrases to allow for intuitive use and their ability to be used in Power Searches (topic covered later). Once you have created the UDC and hit the “+” (plus sign), it appears in the UDC category window.

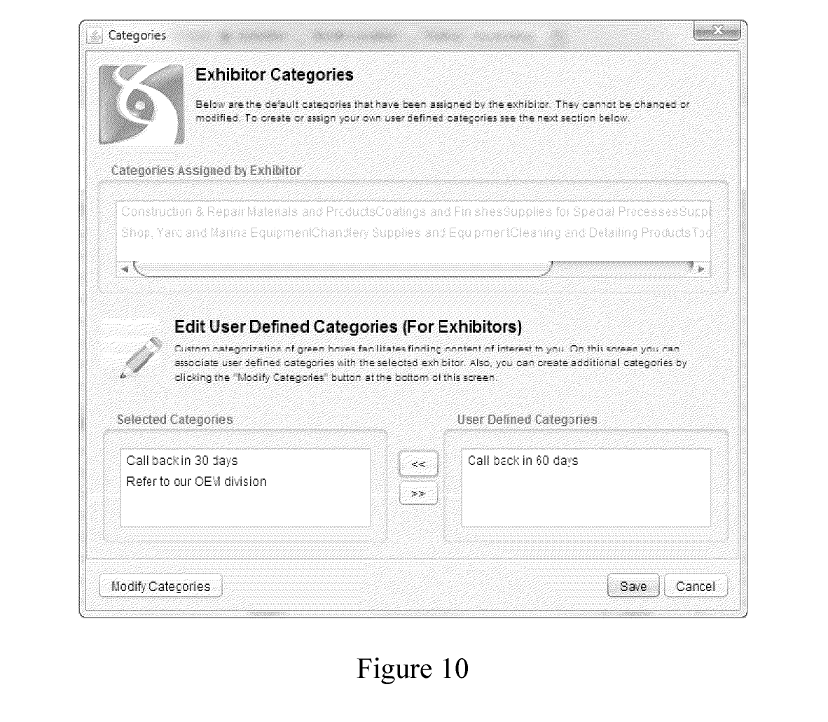

With additional reference to FIG. 10, once you have created one or several UDCs, you can then select one or more UDCs to be assigned to a particular exhibitor. With reference next to FIG. 8B, the selected UDCs are now included in the Categories corresponding to that exhibitor. Further, as shown in FIG. 8C, the Presenter allows you to search by UDCs.

Preferably advanced sorting techniques provide for flexibility in the sorting and use of information. Multiple criteria and complexity can be employed in sorting.

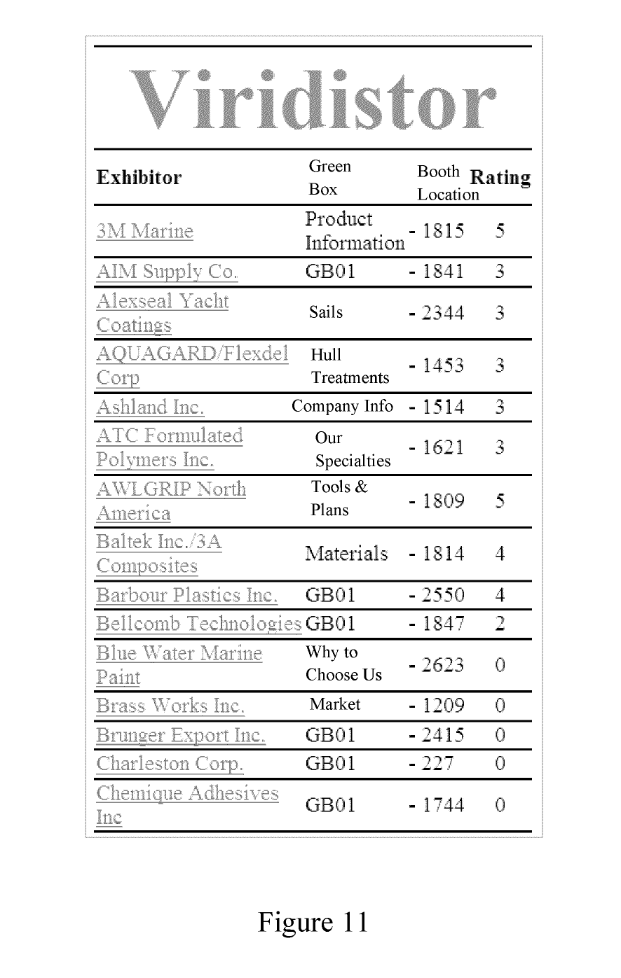

With reference again to FIG. 6, information from this screen can be printed or exported to another device such as a smart phone in one or more formats, such as CSV or HTML format. The format can be changed as desired for the application. For example, with reference next to FIG. 11, a format for use with a smaller smart phone screen condenses information and displays less columns of information than does the full screen version. In some embodiments the user can select which columns will be exported.

Preferably the tab leading to Browse Sessions by Category enables management of data related to conference sessions in a similar manner to that of exhibitors.

The Browse Visited Exhibitors or Sessions Attended allows you to browse all the exhibitors/sessions you have visited, or only those of a particular category.

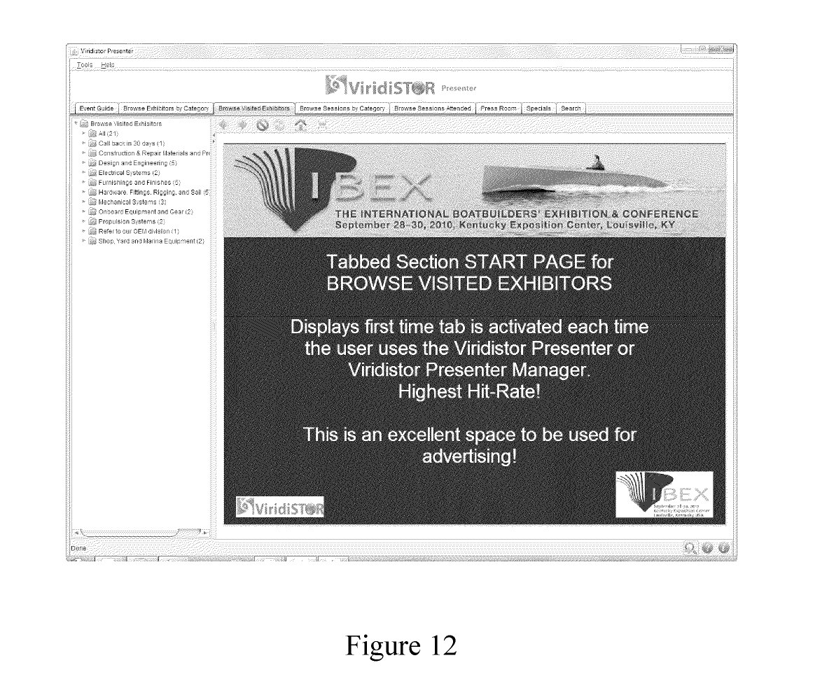

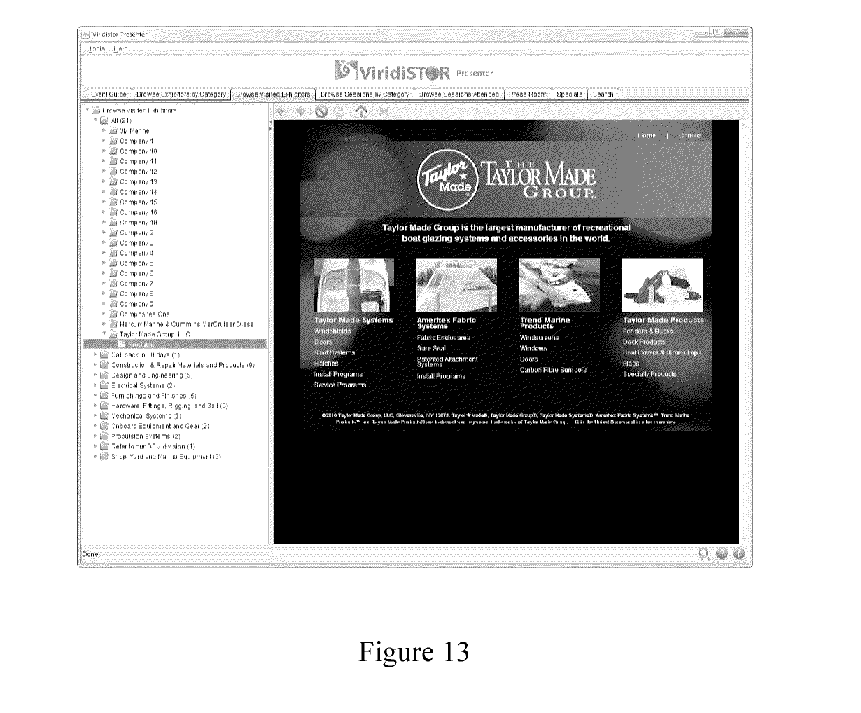

With reference next to FIG. 12, in one embodiment the first time that you activate or move to this tab, you will be presented with a splash screen of content provided by the event, which may include advertising space, instructions, links to comment pages, and the like. There is also a category tree, with an indication of how many exhibitors in a particular category were visited. As shown in FIG. 13, clicking on one of the category folders expands to folders for each visited exhibitor in that category, which in turn expands to a link to that exhibitor's Green Box(es).

It is to be understood that the presentation of the content being fronted, in this case via an HTML page, can be performed in different methods and styles. The current embodiment uses template a style where the complete system automatically offers choices of style and number of items of content (for example, an exhibitor wants to include 1, 2, 3, 4 or some other number of PDF, JPG, PPT or other types of files) and the ViridiSTOR system VUA (ViridiSTOR is the digital administrator) client generates a generic HTML page to present the content incorporating any metadata descriptions, company logos, images, etc. that the system can collect from the exhibitor. In this embodiment, the entire system would be completely automated in setting up for an event when provided with content from exhibitors. Other embodiments may employ other ranges of automation. In another embodiment the exhibitor creates their own HTML front end with custom graphics etc. and then via the VUA, uploads it all to the ViridiSTOR system. In any case, the Presenter, in all embodiments, “presents” the information.

Once you have opened a particular site by selecting the exhibitor name from the Exhibitor column (Internet connection required), you have the option of creating a bookmark or favorite. In one embodiment, this is done by first, opening in a new window the Exhibitor that you visited from the Browse Visited Exhibitors window. Next, in your default browser, create a new favorite folder or new bookmark folder for this event. Once this folder has been created, you may simply add the Exhibitor to that folder.

From your browser, you may add the Exhibitor to your favorite or bookmark folder. You can build subfolders of the favorites or bookmarks to manage the exhibitors in any way you wish. These features make it convenient to compare and contrast the information from the exhibitors of the event. The number of tabs you may have open at any time are a function of the computer, browser, and available memory. Of course, it is to be understood that other methods of marking favorites may be employed.

Some embodiments offer advanced search capability, including all columns of displayed content, all linked content, metadata of the synopsis of the exhibitor, the synopsis of the Green Box content, stock and user-defined categories, etc.

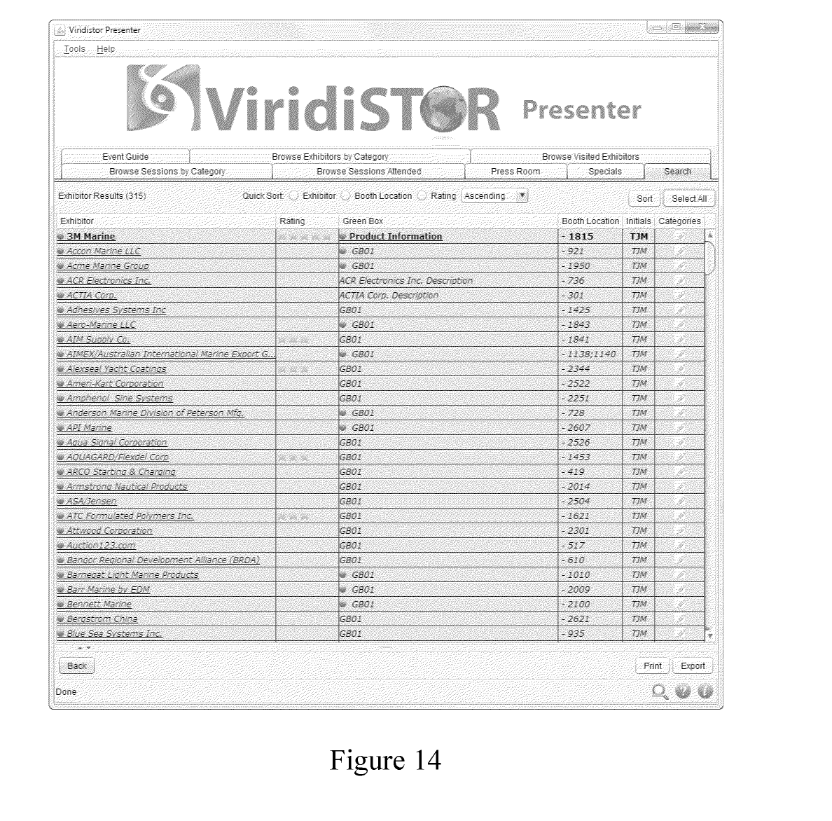

With reference to FIG. 14, in one embodiment, search results are presented in the same format as the page before searching, except that an indicia (such as a dot in the illustrated embodiment) is placed next to the link that contains the matching subject matter.

It is to be understood that the search capability may be expanded to beyond that of the metadata and include both the electronically searchable “content” that is gathered by any means via the systems approaches noted herein, and can be optionally expanded to include the referenced remote content (such as an Internet website or other repository) of the particular participant (for example, the search could be of the content that was captured via the insertion of the USB device into a particular exhibitor's Green Box. That electronic data (PDF, Word, text for example) could also be searched and indexed and then made more “useable” through the Presenter interface. The option to broaden the search to “content” could be user selectable. Furthermore, this broadening could then include “remote” content. For example, if the data from the USB contains a link to a web page, the search utility can open the web page and apply the search criteria. All of these parameters and choice add to the value and functionality of the system in general, and through the use of optional social media options (see later in this document), the “network” of information is boundless and provides an ability to use information based upon a myriad of choice, opinions, recommendations, etc. In some embodiments, a Press Room version of a USB drive will only be distributed to authorized members of the press, and only the Press Room version will include a “Press Room” tab. In other embodiments a Press Room tab is included in all USB drives. Exhibiting companies and presenters of sessions often create press kits that contain everything a reporter needs to write a bang-up story about you and your company. The Press Room USB will contain the Event Guide, Browse Exhibitors by Category, Browse Sessions by Category, Press Room, and Specials tabs. The typical Press Room will include press content segmented by exhibitor and session presenter, when applicable, and may follow the same tree structure display of “all” and by individual categories. The individual press kit can be as simple as a single HTML page with text or a link to content or more complex and organized by pages with different aspects of the company or presenter that the press should be aware of

In some embodiments, a Press Room USB drive can't be used on the show floor and inserted into the Green Boxes and capture content. Further, depending upon the event, attendees of the event to visit the trade show floor will receive an Exhibit Floor USB and attendees of a seminar or conference will receive a Sessions USB. Thus, attendees who register for the Exhibit Floor may only capture content from the Exhibit Floor and not the Sessions, and vice versa. Attendees that have registered for both the trade show floor and sessions will receive a USB enabling content capture on both the Exhibit Floor and Sessions. These USB drives will have the appropriate authorization codes and language codes on them to capture content.

In still further embodiments, the Presenter software may have a “Specials” tab. This section may hold advertisements, new product announcements, or “show specials” for any of the exhibiting or presenting participants of the event, and may have a category tree structure. The size of the content of the Special is limited, so the participant will create an impactful message with links that require Internet connection and or include “promo codes” to participate in discounts or other promotions that they are showing on the Specials tab. Preferably exhibitors will pay extra to be included on the Specials tab, and particularly to be featured on the home page of the Specials tab.

In other embodiments, the Presenter software can be configured to run on a network, so that multiple parties can access the content of any one other party. For example, multiple users may attend the same trade show, but with directions to interact with different exhibitors. Each user may load the content she collected to the network, and each of the users can access all of the content obtained by the other users.

In further embodiments the Presenter software can be configured with a “manager” mode, in which a particular user has greater access rights than other users. Access to manager mode may require a password, and may also require a subscription and registration of the software.

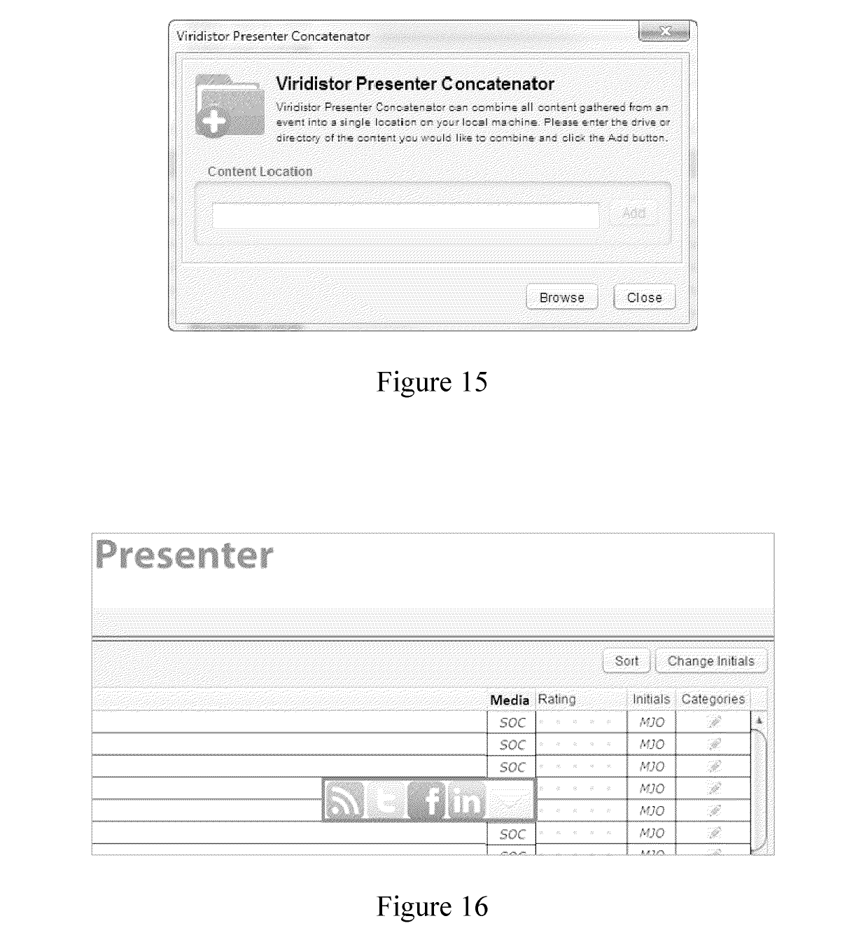

With reference next to FIG. 15, in manager mode, the Presenter software may concatenate diffuse content obtained by other users, and either store or restrict access to that content to the manager. In this context, concatenating diffuse content about a trade show involves presenting the content obtained by multiple users as one collection. The manager can then use the information, along with data tracking which user obtained the information and/or made a rating of a particular exhibitor. The superior rights of the manager mode also enable a manager to override data such as ratings. Also, the Manager may assign his own ratings and or user defined categories (some embodiments may keep a record of the originally-assigned ratings).

In some embodiments, each concatenated data set imports at least: the initials of the associated User; Language-specific content and menus including, but not limited to the Event Guide, Splash Screens for tabs, Specials, Press Releases, etc., and optionally, the user interface language strings to present the program's instructions in the supported languages. (i.e., it may pull over all content that is not in the default language of the Presenter running in the Manager mode and currently available on the User collection; “not visited” or “not attended” listings, but preferably only if the user has rated or created user defined categories for that exhibitor or session; and the actual collected data (exhibitor, session, press, etc.) in the language of the USB, up to and including different language versions of the same “visited” or “attended” exhibitor/session.

The Presenter application can run on a designated system of communicating (wirelessly or via a physical connection etc.) to a smart phone or other device where the user can ‘on the fly’ select ratings and ‘check off’ that they inserted the stick and collected information from booths/conferences/exhibitors etc. in real time (in some embodiments the manager may also monitor the progress and activity of employees at the trade show). In some such embodiments, a third party app or mobile version of the Presenter is loaded on the smartphone, which communicates electronically with the manager.

Further, in some embodiments, a user, manager or enterprise can determine their own User Defined Categories (UDCs) prior to an event. These UDCs can be defined in the Presenter Manager mode. The Presenter Manager will then automatically access the user Presenter applications connected to the network and update the UDCs.

In another embodiment, the Presenter will support the integration and access to social media such as Twitter, LinkedIn, email, Facebook, etc. via an easy access icon. The user of the Presenter will fill in a registration of their own social media information the first time they use the Presenter application. Then, by clicking on the social media icon of the particular exhibitor or presentation, the user of the Presenter will be able to access the type of social media that is available for that exhibitor or presentation.

With reference next to FIG. 16, in such an embodiment, the viewing pane may be modified to have a column with links to social networking sites. The particular exhibitor has several social media options in addition to a direct link to email. In the example, the user selects or “clicks” on the SOC icon (this could be a graphical icon for said action as well). The different social media types are then presented, from which the user may select the option they wish to “subscribe” or act upon, or simply to access the social media corresponding to that exhibitor.

This type of support is not limited to social media, but any other “external” command or type of action. For example, in another embodiment an icon may be provided that prompts interaction between the Presenter and, for example, a business enterprise's customized software that manages vendor relationships. In this example, clicking the icon sends information about a particular exhibitor to the enterprise software and initiates a process to have the exhibitor approved as a vendor for the company based on information managed by the Presenter. Another example would be selecting to have the user of the Presenter send his/her vCard (Short for virtual Card (also called electronic card), vCard is a specification that defines the format of an “Electronic Business Card.” vCards are often attached in e-mail messages, but can also be exchanged through other ways on the World Wide Web. Usually a vCard will contain a business name, address, phone number, URL, logo and other business information.) Thus, as just discussed, it is contemplated that the Presenter may positively interact with other software programs in both a public and nonpublic context.

Still further embodiments may include one or more other features, or may have some structure differing from the specific embodiments discussed herein. For example, in some embodiments the Presenter application may run, or a version of the Presenter may run, on pad or tablet devices, in addition to smart phones or other computing devices. In other embodiments the Presenter application (with trade-show-specific information) may be available for download (or use in “cloud” computing) before the trade show. The user may receive a code for accessing such information only after completing his registration and, in some cases, paying a fee. Alternatively, the fee can be avoided by agreement to allow the administrator to share certain information about the User with specific exhibitors after the event so as to provide leads to the exhibitors.

Further, rather than work with a portable memory device and a content delivery device, the trade show may run a Wi-Fi system dedicated to information transfer to user's Presenter applications. Transfer would be triggered when a user electronically indicates an interest in exhibitor's product such as by inserting a USB, scanning a UPC code (by the exhibitor) or by the attendee using an electronic device such as a smartphone or the like.

In additional embodiments, the Presenter software can include versions for laptops, networks, smartphones, tablets and the like, and may also be configured to integrate with other (and potentially third-party) applications running on smartphones, tablet PCs or the like. As such, through the use of applications running on smartphones or tablet PCs, the rating, categorizing, and notation of exhibitors being visited or not can be exchanged between the portable device and the Presenter application running on the user's computer through an online and/or cloud connection. That information could be such that the user could rate, categorize, etc. a particular set of exhibitors or conference sessions to attend, and then have that “listing” transferred to the smartphone or tablet computer and, in some embodiments, have a tentative schedule developed to enable the user to most efficiently accomplish her plans. Also, as the user of the smartphone or tablet PC application walks the floor of an event, they can rate, mark visited, categorize, etc. the exhibitors or sessions that they interact with, and transfer that information back to the computer hosting and running the Presenter application.

In further embodiments, a user can create their own schedule for visiting specific booths, and view the schedule on a smartphone, tablet computer or the like. In some embodiments, through GPS the user can track their progress through the show and be prompted by their smartphone who to visit next and where they are relative to the user's current position.

In yet another embodiment, the digital content obtained by the User would be time bombed or copy protected. For instance, the content would only be accessible with an access code or password that the user may obtain at the event, or may pay extra to obtain. Also, in some embodiments, the Presenter application could cease to work at a predetermined time, or only work if a password is provided.

In still further embodiments the Presenter application could also contain logic to not allow the unauthorized copying of content to another device or location. (i.e., it would work only on the authorized USB or whatever device the software is delivered and data accumulated upon.

Additionally, in some embodiments the Presenter software will analyze the patterns of data accumulated by the user and suggest other exhibitors or sessions for the User to visit. In still further embodiments, based upon such suggestions the Presenter may access an online database to download content on exhibitors that weren't visited but the Presenter software determines would be of interest to the user.

It is to be understood that all of the embodiments discussed herein are not limited in application to trade shows. Rather, the trade show is presented as a convenient way of showing examples. The Presenter software can also be used with or without content delivery devices. For example, a full USB device, or other portable memory device, can be supplied for an event such as an educational conference. Further, aspects of the system and software discussed herein can be used in many applications, including for example, real estate, Retail, Education, Hospitality, etc. and it is not limited in any way to the type and or variations of business uses it supports.

Another embodiment can employ the Presenter application, but not require content delivery devices as discussed herein. For example, a website can be setup to host all of the exhibitor or session information, and each attendee would setup his own registration (with security) for the event. An application would be available for use on a smartphone or tablet PC, which application would have some sort of validation system (either RFID registration, TAG or QR information capture, or other form of validation) so that said validation or authorization would have to be obtained with permission (security) from the exhibitor or session. This validation would be a way of determining when the user has visited an exhibitor or attended a session.

As the user visits the exhibitors or attends the session, he obtains the validation on his smartphone or tablet. Additionally, he would have the ability to rate, categorize, etc. the exhibitor or session. When completed, or at any convenient time, he would then send or “upload” the requests for information to his account that he has previously setup on the Viridistor digital content administrator server.

Upon completion of uploading of his request, he would then have the ability to “view” and “use” the content that is tied to his requests, either online over the Internet under the control of the Presenter running “on the cloud”, or have the option of having all of the content that he was authorized to obtain downloaded to his local computer, along with the Presenter software application, which then manages and “presents” the information to allow for all of the functions of management of what would otherwise be disparate information.

This embodiment would also support the ability to collect information in different language versions, if available, in addition to interacting with “other users” as noted in the Presenter Manager mode. Also, this same ability would allow for the “combining” of uses (i.e., some would have collected the information virtually via the smartphone or tablet app and others through the use of the physical USB).

In further embodiments, the Presenter can be integrated with smartphone apps. For example, the Presenter software preferably will support the exchange of metadata between smartphone or tablet devices in a bi-directional fashion. This exchange would be accomplished through a variety of methods including physical exchange via a network, a memory device as a transport mechanism, or email exchange of said metadata. The system would support the transfer from the smartphone/tablet app and the Presenter running on a computer or vice versa. Some features that will be supported include the exchange of ratings of the event or session, if the event or session was “visited” or “attended”, or notes made on the event or session. There is no limit to the number or types of possible notations and said notations and can be customized on a case by case basis.

For example, in this embodiment as an attendee walks a trade show floor and visits exhibitors, they would use their smartphone app to set a rating of one to five stars, if they “visited” the booth or not (this would not eliminate the need to collect the “content” with the Viridistor USB), and the ability to make notes about the booth/exhibitor.

In another example, the user of the Presenter software may rate in advance or set categories in the Presenter on the PC or Mac, and then send those ratings to the app running on the smartphone or tablet.

In addition embodiments, the Presenter software is configured to track and report the actual use or opening of content by a user. This reporting would be on all levels of content, from opening individual content within the Browse Visited Exhibitor tab, to opening content from the Green Box column, or Exhibitor links from the Browse Exhibitors by Category tab. This same capability would be available on all tabs of the Presenter.

In one such embodiment, upon the first use of the Presenter and or changing of the initials of the user of the Presenter, the user would be required to input their contact information (name, company, phone number, email, etc.). The Presenter would then log all use of the content on the Presenter USB itself, or its use on the computer. At shut down or start up or another relevant trigger event, the Presenter application would check for Internet connection and then upload this data to an administrator server that is administered by the data administrator which may be, for example, applicant.

At predetermined time intervals, the data administrator servers would generate reports of use for the exhibitors who would have subscribed to this reporting option and send reports to them. Again, any level of granularity of what information was accessed by the user could be provided. Reporting could include the date, time, item opened, the user's rating of the exhibitor, etc. and by whom etc. In some embodiments this logging and reporting feature could be an option—this decision would be made by the event management or whomever the data administrator contracts with, who may make it a condition of use at their event.

Variations on this concept are also to be considered. For example, in some embodiments only non-personally-identifying data is communicated to the exhibitors. In still further embodiments information regarding use of the content may additionally or alternatively be uploaded to an administrator version of the Presenter within the enterprise's network.

In another embodiment, when or after collecting demographic information, the Presenter reports to the data administrator server system the visits or collections of which booth or session was visited. This satisfies the support of a next-generation lead retrieval solution with many enhancements to ensure the metrics have value to the participants (exhibitors, event producers, etc.). In this option, the first time that the user of the Presenter starts the Presenter application, they will be required or prompted to fill in their “lead tracking” or demographic information. This information, designated by the event producers or management, may include name, company/organization, email address, phone number, physical address etc. This is not limited to any set of demographic information.

If the user of the Presenter first uses it in the offline mode (no Internet present), the application will store or cache the registration information, and wait for the first opportunity to send the information to the data administrator server systems. An option to disable the use of the system (optionally delete information) after a predestinated number of uses without the registration being sent to the servers is an option in some embodiments.

In this embodiment the system is designed to ensure that the polling or reporting of information will be updated to ensure that the registration gathers the visited content. For example, one embodiment could have the Presenter application(s) delivered prior to an event and the participant fulfills the registration prior to collecting data. The application will be programmed such that it makes contact with the data administrator servers after content is added, and as a failsafe, at a predetermined time after the event to ensure the most accurate representation of whom the participant visited is captured. Other situations that would trigger such an update of the collected information on the data administrator server would be any use of the “Manager” mode when the collection is added to via that feature or at any time replications are made and new registrations occur. The data administrator servers will maintain date/time, content, and change logs to ensure that the profile for each participant and what that participant visited or attended is as accurate as possible and can be then provided to the event producers, exhibitors, etc.

In additional embodiments the registration information collected may be cross-referenced with the collected registration information managed by the event producer. If the registration information did not match, for example, an attendee's email address, the data administrator system and or Presenter may take actions such as limited access, require additional information, etc. to validate and add value to the use of the system. Through this same methodology, access to the information provided on the Presenter applications or information collected at the event could be controlled, limited, etc. Last, having knowledge metrics of who was or was not at the event would be provided to the event producer and or exhibitors for access control, lead tracking or other business reasons and actions.

In further embodiments, when Internet access is available, the Presenter will send to the data administrator servers a list of each booth, session, etc. that the USB of the participant (if that mode of collection was used) visited (i.e., inserted into a Green Box or other embodiment). This function need only to take place one time (optionally).

Further embodiments would enable option for more than one type of registration. For example, the event may require that the registration be completed to use the Presenter and content from the event, but offer the option of participation in the ongoing demographic use collection. The condition of use may offer the extra value of participation to then support the option of “dynamic information” updating as noted herein. Further, a user who consents to participate may receive an incentive such as a discount. In this manner, the goal of “lead retrieval” is addressed in many forms, without the need of preregistration of the participants' information, the support of optional levels of “lead tracking” and subsequent reporting to the data administrator system, which then would either supply said demographic information to the event producer and or the exhibitors, etc. directly, and eliminate the need for conventional lead retrieval systems that must then be downloaded and information sent to the respective user (exhibitor at a booth for example).

Within the data administrator system, the Green Box devices preferably track the number of visits (insertions of USB devices, for example, into the unit). This information preferably is downloaded at a later date and each participant (exhibitor from that booth), receives the notification of how many “impressions” were made at the event, etc. Thus, exhibitors are given immediate feedback on the distribution of their materials. In some embodiments the Green Box device does not collect any demographic information for the visitor (in other embodiments, the collection of this type of demographic at the device level (Green Box) or other collection system may be supported). This feature, coupled with the documented “lead tracking” as provided by the Presenter application as noted herein, provides business information to the participant (exhibitor from with the booth) to know who came by their booth and then later, at a minimum, the basic registration from which the visitors' contact and business information is delivered to the event producer and or exhibitor etc. once the user completes the registration process.

In some embodiments the lead tracking features will be supported in all facets of the Presenter and data administrator system, in addition to the use of “replication” or sharing of content, where upon a replication, the Presenter would “reset” the demographic collection fields of the application and require the “new user” to complete said registration. This would offer the ability to track and deliver information to the event producer and or exhibitors, for example, of an “extended audience” of individuals who may not have even attended the event, but were now able to access and be exposed to the content/information of said event, potentially offering even more prospective “buyers” or attendees of an event which adds value to not only the event producer, but to the exhibitors themselves. The option exists for the data administrator system to “cross match” and determine if new registrants a) did actually attend the event, determined by cross-matching with the registration information gathered by the event producers or b) resulted from the sharing of information beyond that of physically attending the event. Upon the delivery of said demographics and metrics, the event producer may elect to charge for the expanded exposure as provided through the use of the data administrator systems and the Presenter systems. It is conceivable that this charge could also be applied to the user of the information via the Presenter as an option before the Presenter would fully function. An example of this use would be a conference where participation and use of “materials and handout content” that is managed by the Presenter is on a paid basis. In sharing, the option of basic protection and requirement of payment before access could be provided for, including encryption of content itself as contained and managed by the Presenter application.

All of these embodiments may be expanded upon with all uses of the many uses and structural iterations of the Presenter systems and the data administrator system in total.

In still another embodiment, online communication between Presenter software and the data administrator server is used to allow for updates to information already gathered and saved on the particular instance of the Presenter. For instance, at startup or upon a manually triggered event, the Presenter would contact the data administrator servers in connection with the particular event. If the user of the Presenter has properly registered with the data administrator server, the Presenter would check for new or updated content for the exhibitors, or sessions, they attended. If the updated content is available, as the exhibitor would have had to agree to the terms of participation with this option & provided content to be posted on the data administrator server, the Presenter would then receive the update and install it onto the instance of the Presenter. This update would include updated information in addition to additional information that the exhibitor wishes to provide, along with a new (if desired) landing page for that exhibitor.

Optionally, exhibitors that were missed during the event could offer their full content and the user of the Presenter would, for example, check a check box to see which exhibitors that were missed are now offering said content. A dialog box would notify the user of the Presenter of this content. The user of the Presenter would then select which content they want to receive. This option would be recommended for use only while the Presenter is running on a computer, as it would potentially exceed the capacity of the original USB device. Of course, however, future USB or other portable devices may be capable of accommodating such memory requirements.

Preferably, the user would have the option of reviewing the list of content that is an update to existing content or new content that is available for exhibitors that were not visited (i.e. the USB used for collection was never inserted into that particular exhibitor's Green Box). This information could be listed by name of exhibitor, category of exhibitor, etc.

The Presenter software can be used for a single event, such as a single trade show, or can be used to catalog/maintain data from several such events, or even several different types of events, or different types of digital content delivery. For example, a Presenter package may monitor and archive in an organized and easily-accessible manner all of an organization's trade show attendance over a period of many years. Such trade shows can be sorted by name, subject matter, product line, etc. Still further, and at the same time, the same Presenter software can keep track of materials received at conventions, and the like. Yet further, the Presenter software can keep track of materials at internal training sessions. Along the lines of this example, the Presenter software can be used to keep track of disparate, seemingly unrelated information.

Although the inventions herein have been disclosed in the context of certain preferred embodiments and examples, it will be understood by those skilled in the art that the present inventions extend beyond the specifically disclosed embodiments to other alternative embodiments and/or uses and obvious modifications and equivalents thereof. In addition, while a number of variations have been shown and described in detail, other modifications, which are within the scope of this invention, will be readily apparent to those of skill in the art based upon this disclosure. It is also contemplated that various combinations or sub combinations of the specific features and aspects of the embodiments may be made and still fall within the scope of invention. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

What is claimed is:

1. A method for delivering and managing digital content, comprising:
distributing a portable memory device having an information management software stored therein, each portable memory device having a first group of data concerning a plurality of content delivery devices;
engaging the portable memory device with a plurality of the content delivery devices so that digital content from the engaged content delivery device is delivered to the portable memory device;
engaging the portable memory device with a computing device to access and manage the digital content received from the plurality of content delivery devices;
wherein the digital content can be searched by category, and such searching will include the first group of data.

2. A method, comprising:
obtaining digital content from exhibitors or presenters at an event;
providing a portable memory device to attendees at the event, the portable memory device having the digital content from the exhibitors and an information management software stored thereon, wherein the information management software is configured to be transferred to a computing device along with the digital content, and wherein the information management software manages the digital content.

3. The method of claim 2, wherein the information management software automatically accesses a content administrator server online and updates the digital content.
